(19) United States
(12) Patent Application Publication
(10) Pub. No.: US 2019/0048913 A1
(43) Pub. Date: Feb. 14, 2019

(54) BLIND FASTENER WITH A SLOTTED EXPANSION BODY

(71) Applicant: MONOGRAM AEROSPACE FASTENERS, INC., Los Angeles, CA (US)

(72) Inventor: Brandon Michael ROSENBERG, La Habra, CA (US)

(21) Appl. No.: 16/057,876

(22) Filed: Aug. 8, 2018

Related U.S. Application Data
(60) Provisional application No. 62/542,418, filed on Aug. 8, 2017.

(51) Int. Cl. F16B 13/06; F16B 5/02

(52) U.S. Cl. CPC F16B 13/061; F16B 5/0258

(57) ABSTRACT

A fastener includes a bolt, a body, a sleeve, and a nut. The bolt is disposed through the body, the sleeve, and the nut. The body abuts the sleeve. The sleeve abuts the nut. The body includes grooves formed in an end near the sleeve. The sleeve is deformed and forced into the grooves. Rotation of the sleeve relative the body is arrested or reduced without formation of stress risers or splits.

### CROSS-REFERENCE TO RELATED APPLICATION(S)

This application claims the benefit of U.S. Provisional Patent Application No. 62/542,418, entitled “BLIND FASTENER WITH A SLOTTED EXPANSION BODY,” filed on Aug. 8, 2017, which is hereby incorporated by reference

### TECHNICAL FIELD

This disclosure relates to a fastener, and, more specifically, to a blind fastener

### BACKGROUND

Rivets and other types of fasteners are used in manufacturing to hold workpieces together. Such rivets may hold together metal or other materials and may be high-strength fasteners. In some manufacturing operations, apertures are drilled through workpieces and then fasteners are installed in the apertures.

Blind fasteners can be used to connect two or more components together when access to one side of the components is limited. Blind fasteners are also used with robotic assembly equipment to eliminate the need to coordinate activity on both sides of a fastener. By way of example, blind fasteners are used to attach workpieces together.

Blind fasteners are traditionally used in the aircraft industry. Such fasteners generally include a nut or body, a bolt and a sleeve. The nut has a body with a threaded axial bore therethrough. A bolt is threaded in the body. A hollow cylindrical sleeve surrounds the bolt between the body and a head of the bolt. In installation, the fastener is aligned in holes in workpieces. As the bolt is drawn through the bore of the body, the sleeve is pushed by the bolt head and is deformed against the workpieces thus locking the fastener in position. Once locked, a portion of the bolt above the workpieces is removed and discarded. This portion typically breaks off from the remainder of the bolt.

In some blind fasteners, the body has a nose with knurls formed thereon. As the sleeve is deformed against the workpiece the knurl may reduce rotation of the sleeve relative the body. The knurls protrude or cut into the sleeve and may cause a split or stress risers. If the sleeve rotates, the blind fastener may fail to install or may install incorrectly. If the sleeve is split, the fastener may need to be removed and discarded.

For these and other reasons, there is a need for a fastener which operatively prevents rotation of the sleeve relative the body. There is also a need for a fastener that reduces or prevents certain failures in installation. Moreover there is a need for a more efficient fastener, system, and methods for forming or installing a fastener.

### SUMMARY

The following presents a summary of this disclosure to provide a basic understanding of some aspects. This summary is intended to neither identify key or critical elements nor define any limitations of embodiments or claims. Furthermore, this summary may provide a simplified overview of some aspects that may be described in greater detail in other portions of this disclosure.

Described herein is a blind fastener for inserting through aligned apertures, the blind fastener comprising a bolt comprising a bolt head and an externally threaded portion, a body comprising a body head on a first end, an external tapered ramp surface on a second end, wherein the external tapered ramp surface comprises at least one groove extending along the external tapered ramp surface and wherein, the at least one groove defines a variable maximum depth relative to the external tapered ramp surface such that at a first point the maximum depth of the at least one groove is at least twice as deep as at a second point along a length of the at least one groove, and a sleeve comprising a first end, a deformable portion adjacent the first end, a second end, and a sleeve bore extending through the sleeve along the longitudinal axis, wherein the bolt passes through the sleeve bore, wherein, first end of the sleeve abuts the body, and wherein the deformable portion is deformable over the at least one groove to reduce rotation of the body relative the sleeve.

In another aspect, the blind fastener may further comprises a nut comprising an internally threaded portion, wherein the nut is threadingly engaged with the externally threaded portion of the bolt and wherein the sleeve is positioned between the nut and the body. The external tapered ramp surface includes a tapered nose portion proximate to the second end. The at least one groove does not extend longitudinally along the tapered nose portion. A slope of the tapered nose portion is different than a slope of the external tapered ramp surface. The slope of the tapered nose portion is steeper relative to the longitudinal axis than the slope of the external tapered ramp surface. A bottom surface of the at least one groove is radiused along the length of the groove. A maximum depth of the at least one groove is positioned near a longitudinal general midpoint of the external tapered ramp surface. A maximum depth of the at least one groove is positioned between a longitudinal general midpoint of the external tapered ramp surface and the second end of the body. A bottom surface of the at least one groove includes a first surface having a first gradient and a second surface having a second gradient different than the first gradient. The first gradient and second gradient are different than the slope of the external tapered ramp surface. The first surface is at least one of generally parallel to the longitudinal axis, or curved such that the first surface has a variable gradient along a length of the first surface. In an example, when moving longitudinally over the external tapered ramp, a portion of the sleeve extrudes at least partway into the at least one groove. The at least one groove extends substantially in a longitudinal direction relative the longitudinal axis. The deformable portion comprises an enlarged bore that has a larger internal diameter than the sleeve bore. The blind fastener may further comprise an insert positioned within the enlarged bore between the sleeve and the bolt.

A blind fastener for fastening workpieces together may comprise a bolt comprising an externally threaded portion, a body comprising, an internally threaded bore that operatively receives the externally threaded portion, a frustoconical portion comprising an external tapered ramp surface and at least one groove extending along the external tapered ramp surface and wherein, the at least one groove defines a variable maximum depth relative to the external tapered ramp surface such that at a first point the maximum depth of the groove is at least twice as deep as at a second point along the length of the at least one groove. The blind fastener may further comprise a sleeve comprising a first end, a deformable portion adjacent the first end, and a second end, wherein the sleeve defines a sleeve bore extending through the sleeve along the longitudinal axis that operatively receives the bolt, and wherein the deformable portion is operatively deformed within the at least one groove when compression force is applied to the sleeve. It is noted that the blind fastener may further comprise a nut comprising an internally threaded portion threadingly engaged with the externally threaded portion, wherein the sleeve is positioned between the nut and the body, wherein rotation of the bolt relative to the body longitudinally moves and laterally expands the deformable portion over the external tapered ramp surface until the blind fastener is in an installed configuration. The depth of the at least one groove is nearly zero near a junction between the external tapered ramp surface and an outer surface of the body.

Also described is a blind fastener for inserting through aligned apertures of first and second overlapping workpieces to secure the workpieces together, the overlapping workpieces defining a shear plane between them, where the blind fastener has a pre-installation configuration and an installed configuration, the blind fastener comprising a bolt comprising a bolt head and an externally threaded portion; a body comprising a body head on a first end, an external tapered ramp surface on a second end, and an outer surface between the body head and the external tapered ramp surface, wherein the body defines a body bore extending through the body along a longitudinal axis, wherein at least a portion of the body bore is internally threaded and threadingly engaged with the externally threaded portion, wherein the external tapered ramp surface defines a groove extending along the external tapered ramp surface and wherein, along a length of the groove, the groove defines a variable maximum depth relative to the external tapered ramp surface such that at a first point the maximum depth of the groove is at least twice as deep as at a second point along the length of the groove; and a sleeve comprising a first end, a deformable portion adjacent the first end, and a second end, wherein the sleeve defines a sleeve bore extending through the sleeve along the longitudinal axis, wherein the bolt passes through the sleeve bore, wherein, in the pre-installation configuration, the first end of the sleeve abuts the body, wherein the sleeve is positioned between the bolt head and the body, wherein rotation of the bolt relative to the body longitudinally moves and laterally expands the deformable portion over the external tapered ramp surface until the blind fastener is in the installed configuration against the second overlapping panel and wherein the sleeve interacts with the at least one groove when moving longitudinally relative to the external tapered ramp thereby reducing rotation of the sleeve relative to the body during installation.

The foregoing embodiments are merely exemplary of some of the aspects of the system. Additional features and elements may be contemplated and described herein. Also, features from one of the foregoing embodiments may be combined with features from any of the other foregoing embodiments. The following description and the drawings disclose various illustrative aspects. Some improvements and novel aspects may be expressly identified, while others may be apparent from the description and drawings.

### DESCRIPTION OF THE DRAWINGS

The accompanying drawings illustrate various systems, apparatuses, devices and methods, in which like reference characters refer to like parts throughout.

FIG. 1 illustrates a side elevational view with a partial cross section of a blind fastener incorporating a first embodiment of a slotted expansion body in accordance with the present disclosure;

FIG. 2A illustrates a side elevational cross-sectional view of the FIG. 1 blind fastener in an installed configuration in accordance with the present disclosure;

FIG. 2B illustrates a top plan view of the FIG. 2A installed configuration in accordance with the present disclosure;

FIG. 3 illustrates a perspective view of the FIG. 1 slotted expansion body in accordance with the present disclosure;

FIG. 4 illustrates a side elevational view of the FIG. 1 slotted expansion body in accordance with the present disclosure;

FIG. 5 illustrates a side elevational cross-sectional view of the FIG. 1 slotted expansion body in accordance with the present disclosure;

FIG. 6 illustrates an exploded detail of FIG. 5 in accordance with the present disclosure;

FIG. 7 illustrates a top plan view of the FIG. 1 slotted expansion body in accordance with the present disclosure;

FIG. 8 illustrates a bottom plan view of the FIG. 1 slotted expansion body in accordance with the present disclosure;

FIG. 9 illustrates a bottom plan cross-sectional view of the FIG. 1 slotted expansion body in accordance with the present disclosure;

FIG. 10 illustrates an exploded detail of FIG. 5 in accordance with the present disclosure;

FIG. 11 illustrates an alternative embodiment of groove configuration for the FIG. 1 slotted expansion body in accordance with the present disclosure;

FIG. 12 illustrates another alternative embodiment of a groove configuration for the FIG. 1 slotted expansion body in accordance with the present disclosure;

FIG. 13 illustrates a side elevational view with a partial cross section of a blind fastener incorporating a slotted expansion body in accordance with the present disclosure; and

FIG. 14 illustrates a side elevational cross-sectional view of the FIG. 13 blind fastener in an installed configuration.

The invention may be embodied in several forms without departing from its spirit or essential characteristics. The scope of the invention is defined in the appended claims, rather than in the specific description preceding them. All embodiments that fall within the meaning and range of equivalency of the claims are therefore intended to be embraced by the claims.

### DETAILED DESCRIPTION

Reference will now be made in detail to exemplary embodiments of the present invention, examples of which are illustrated in the accompanying drawings. It is to be understood that other embodiments may be utilized and structural and functional changes may be made without departing from the respective scope of the invention. Moreover, features of the various embodiments may be combined or altered without departing from the scope of the invention. As such, the following description is presented by way of illustration only and should not limit in any way the various alternatives and modifications that may be made to the illustrated embodiments and still be within the spirit and scope of the invention.

As used herein, the words “example” and “exemplary” mean an instance, or illustration. The words “example” or “exemplary” do not indicate a key or preferred aspect or embodiment. The word “or” is intended to be inclusive rather than exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggests otherwise.

As used herein, a fastener may refer to various types of rivets, screws, bolts, or the like. Such fasteners may comprise metals, plastics, or other materials. For example, fastener may refer to a cylindrical rivet comprising a metal body (e.g., aluminum, steel, etc.). Moreover, embodiments may refer to a specific type of fastener for simplicity of explanation. As such, disclosed aspects may be applicable to various other types of fasteners.

Blind fasteners may be used where there is limited operating room, to reduce installation costs, or to reduce installation time in comparison to two-piece non-blind fasteners. Blind fasteners are more readily and cost effectively adapted to automated or robotic installation than would be a two-piece system. For these and other reasons, blind fasteners are considered for non-typical applications wherein access is available but productivity demands and cost concerns drive the use of automation.

Disclosed herein is a deformable portion incorporated in a blind fastener that is deformable from a shape that fits through an aperture to an enlarged shape that provides a clamping surface on the blind side of the aperture the clamp previously passed through. The terms “bulb,” “bulbed,” and “bulbing” are used herein to describe the deformation process and the result of that process where the outer diameter of the deformable portion swells upon application of a compressive load that deforms and/or buckles the deformable portion in a predetermined fashion to form the desired blind side clamping surface to complete the installation. Various embodiments of blind fasteners are disclosed herein. Aspects of these embodiments may be combined, removed, or otherwise modified unless explicitly stated or context warrants otherwise.

As used herein, terms such as “above,” “top,” “second end” and “front side” refer to the head side of the blind fastener that includes the head portions of the bolt and body that is illustrated as located on the accessible side of the work pieces. Additionally, terms such as “bottom,” “below,” “first end” and “back side” refer to the side of the blind fastener that passes through the work pieces and may include the portions of the bolt, body, nut and the sleeve that are located on the blind side of the work pieces. It is noted that the terms describing a relative position are utilized with reference to the drawings. As such, different nomenclatures or naming conventions may be utilized.

Although the fasteners of the present disclosure are described as being for use in aircraft structures, the fasteners may be used for any application in which a blind bolt can be utilized, for example, in submersibles, race cars, and the like.

“Wrenching portions” and “wrenching surfaces,” as used herein, are intended to accommodate any known surface that can be used to engage a manual or automatic tool, including a cylindrical surface engageable by a one-way clutch or roller clutch. The blind fasteners disclosed herein can be used in both manual and automated applications. Use of cylindrical surfaces instead of wrenching flats makes it easier to use blind fasteners with automated installation robots. Conversely, in manual applications, human operators are adept at adjusting parts as required to fit geometric wrenches, and geometric wrench apparatus are generally less expensive than one-way clutches. So other applications lend themselves to the use of conventional wrenching surfaces. Furthermore, the terms “user,” “installer,” “technician,” and the like are employed interchangeably throughout the subject specification, unless context suggests otherwise or warrants a particular distinction among the terms. It is noted that such terms may refer to human entities or automated components. As such, embodiments may describe a user action that may not require human action.

Disclosed is a blind bolt fastener that includes a threaded nut and bolt combination that passes through a deformable sleeve that has a shoulder, a deformable portion and a non-deformable portion. Upon tightening of the threaded bolt and nut combination, the deformable portion is compressed so that it bulbs to form a bulbed head. The shoulder on the sleeve blocks further compression of the deformable portion once the bulbed head is substantially completely formed.

Described embodiments may provide for threaded blind fasteners with a bolt, a body, and a sleeve, wherein rotation of the sleeve is reduced or prevented during installation through one or more slots or grooves formed at an external surface of the body. It is noted that the terms slot and groove may be used interchangeably herein. In some examples, the body may include a plurality of radial grooves that may be formed at or near an end of the body proximal the sleeve. During installation, compression forces applied to the sleeve cause the sleeve to expand over the grooves. The void space of the grooves allows the compressed sleeve material to flow into and engage the grooves. The sleeve material within the grooves may prevent rotation of the sleeve relative the body.

In at least one described embodiment, a body may comprise i grooves spaced apart along a nose of the body facing the sleeve, where i is a number. For example, a body may comprise four grooves generally equally spaced about a perimeter of a nose of the body. As the sleeve expands over the nose it comes in contact with the four grooves. The grooves are able to attach to the sleeve through the compressive forces the sleeve undergoes as it expands over the groove. The voids that the grooves create allow the compressed sleeve material to flow into and engage the groove. With the grooves engaged to the sleeve, the sleeve does not rotate and may fully compress against the structure until installation is complete.

Such fasteners may comprise aluminum, steel, or other materials. Embodiments include radial grooves formed in a body to facilitate engagement with a sleeve. The aspect of arresting the rotation may be accomplished by means of interference with the sleeve and the radial grooves. In another example, an indent may ______.

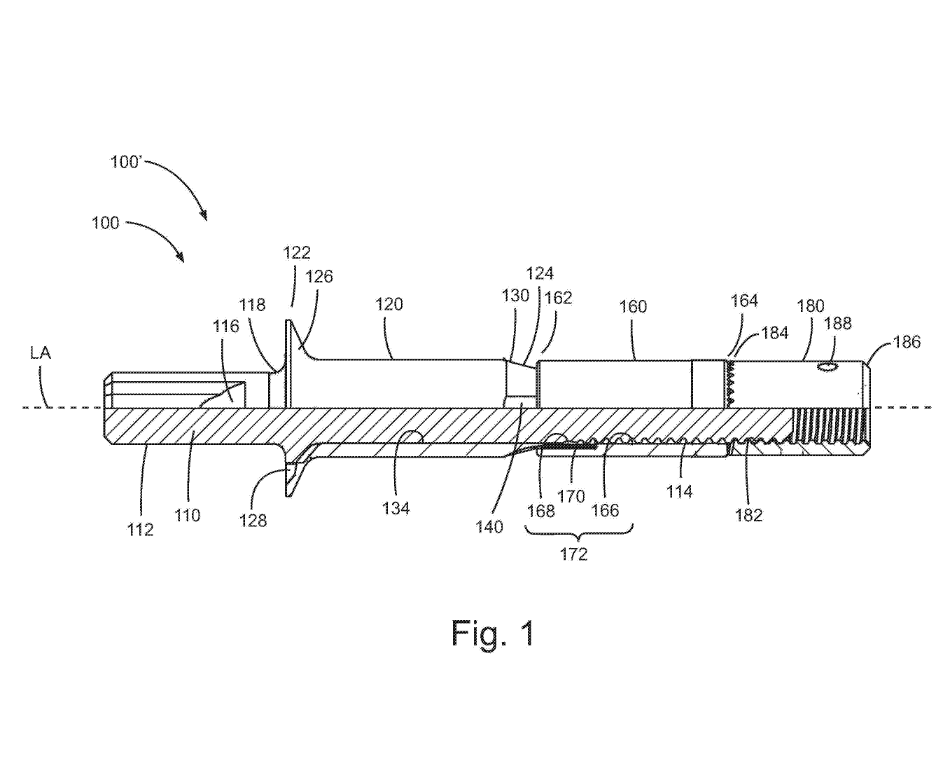

Referring to FIG. 1, blind fastener 100 is illustrated in pre-installation configuration 100′. Blind fastener 100 may primarily include a bolt 110, a body 120, a sleeve 160 and a nut 180. Blind fastener 100 defines longitudinal axis LA that extends for along the length of bolt 110. Blind fastener 100 may allow for arresting rotation of sleeve 160 relative to body 110 during at least a portion of an installation process.

Bolt 110 may include a head 112, a threaded portion 114, a wrenching surfaces 116 and a break feature 118 located between a wrenching surfaces 116 and a head 112. Body 120 includes a first end 122, a second end 124, a head 126 on the first end 122, a wrenching surfaces 128 on the head 126, a tapered ramp 130 on the second end 124, an outer surface 132 and an inner bore 134 that extends between the first and second ends 122 and 124, and which may receive the rotating bolt 110. Tapered ramp 130 may include one or more grooves 140 extending longitudinally along tapered ramp 130. It is noted that tapered ramp 130 may comprise a generally frustoconical section, a taper, a bevel, a concave portion, or the like.

Sleeve 160 may include a first end 162, a second end 164, a bore 166 extending between the first and second ends 162 and 164, and an enlarged bore 168 proximal the first end 162. As described below, sleeve 160 includes a deformable portion 172 proximal the first end 162. At least part of deformable potion 172 includes a longitudinal length of enlarged bore 168. In an aspect, the rotating bolt 110 may be inserted within the enlarged bore 168 and bore 166. In another aspect, at least a portion of the second end 124 of the body 120 may be inserted within the enlarged bore 168.

In at least one embodiment, the fastener 100 may include an insert 170. The insert 170 may be positioned between the between enlarged bore 168 and the bolt 110. The insert 170 may be generally cylindrical in shape, semi-circular, or may comprise other desired shapes. For instance, the enlarged bore 168 may comprise an internal diameter that is generally larger than the outer diameter of bolt 110. The relative sizes may allow a void to be formed between the enlarged bore 168 and bolt 110. The insert 170 may optionally be positioned inside the void defined between enlarged bore 168 and bolt 110. Insert 170 may be constructed of a material that is more easily deformed than the material from which sleeve 160 is constructed. In one example, sleeve 160 may comprise metal and the insert 170 may comprise plastic. It is noted that the insert 170 may be separately constructed from enlarged bore 168 and bolt 110, may be a material deposited onto or within the enlarged bore 168 or bolt 110, or the like.

Nut 180 may comprise an internally threaded bore 182 that is threadingly engaged with a threaded portion 114 of the bolt 110. The nut 180 comprises a first end 184 and a second end 186. In at least one embodiment, the nut 180 may include indent 188. The indent may operatively lock internally threaded bore 182 and threaded portion 114 together to retain the illustrated relative position of the components in the absence of an applied relative torque between bolt 110 and nut 180. It is noted that nut 180 and the bolt 110 may be attached or coupled together via other components.

As shown, bolt 110 extends through sleeve 160, body 120, and nut 180. The sleeve 160 may be positioned between body 120 and nut 180, with first end 162 abutting tapered ramp 130 and second end 164 abutting the first end 184 of the nut 180. Second end 164 of the sleeve 160 and first end 184 of the nut 180 are configured to engage each other such that relative rotation between nut 180 and sleeve 160, in a tightening direction, is reduced or eliminated. For instance, the first end 184 of the nut 180 may comprise a knurled surface that may compress against the second end 164 of the sleeve 160 when compressed for installation. It is noted that the second end 164 may additionally or alternatively comprise a knurled surface. Moreover, sleeve 160 and nut 180 may resist relative rotation via other components, such as adhesives, welds, or the like.

As described above the first end 162 abuts tapered ramp 130. The abutment of first end 162 and tapered ramp 130 resists relative rotation between body 120 and sleeve 160 so that rotating bolt 110 relative to body 120 in a tightening direction moves nut 180 toward body 120 thereby advancing sleeve 160 over tapered ramp 130. As described herein, the sleeve 160 is deformed and may interact with grooves 140. The interaction between the sleeve 160 and grooves 140 may reduce relative rotation between body 120 and sleeve 160 during such advancement.

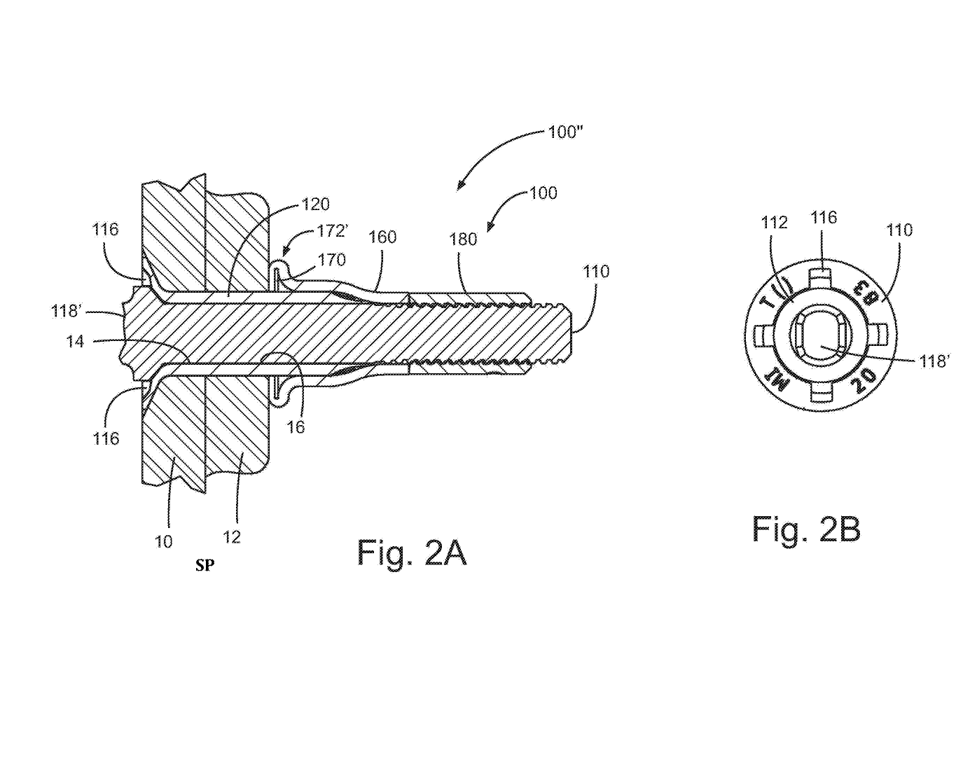

Referring to FIGS. 2A and 2B, the blind fastener 100 is illustrated in installed configuration 100″. Blind fastener 100 is fastening workpieces 10 and 12 together. In an aspect, the workpieces 10 and 12 defining shear plane SP that is between workpieces 10 and 12. Blind fastener passes through apertures 14 and 16. In installed configuration 100″, tightening bolt 110 relative to body 120 has advanced nut 180 toward body 120 thereby advancing sleeve 160 over tapered ramp 130 until end 162 abuts workpiece 12, and continues to bulb outwardly until the illustrated installed configuration 100″ is reached. Once configuration 100″ is reached, the applied torque between bolt 110 and body 120 exceeds a designed failure strength of break feature 118 resulting in the end of bolt 110, that includes wrenching surfaces 116, to break off. This may leaving sheared surface 118′ and ending the installation of blind fastener 100. It is noted that the sheared surface 118′ may be flush, recessed, or may protrude from the workpiece 10. In some embodiments, a user may utilize other or additional tools to finish the sheared surface 118′ according to design specifications.

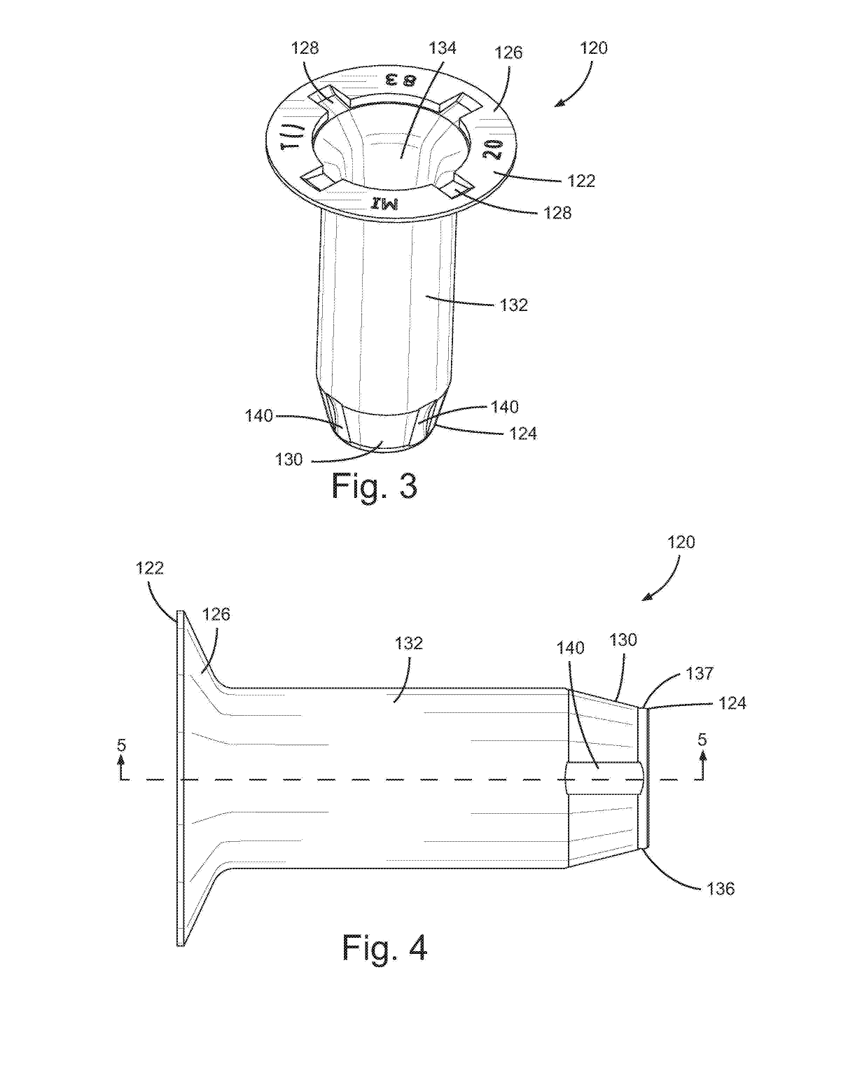

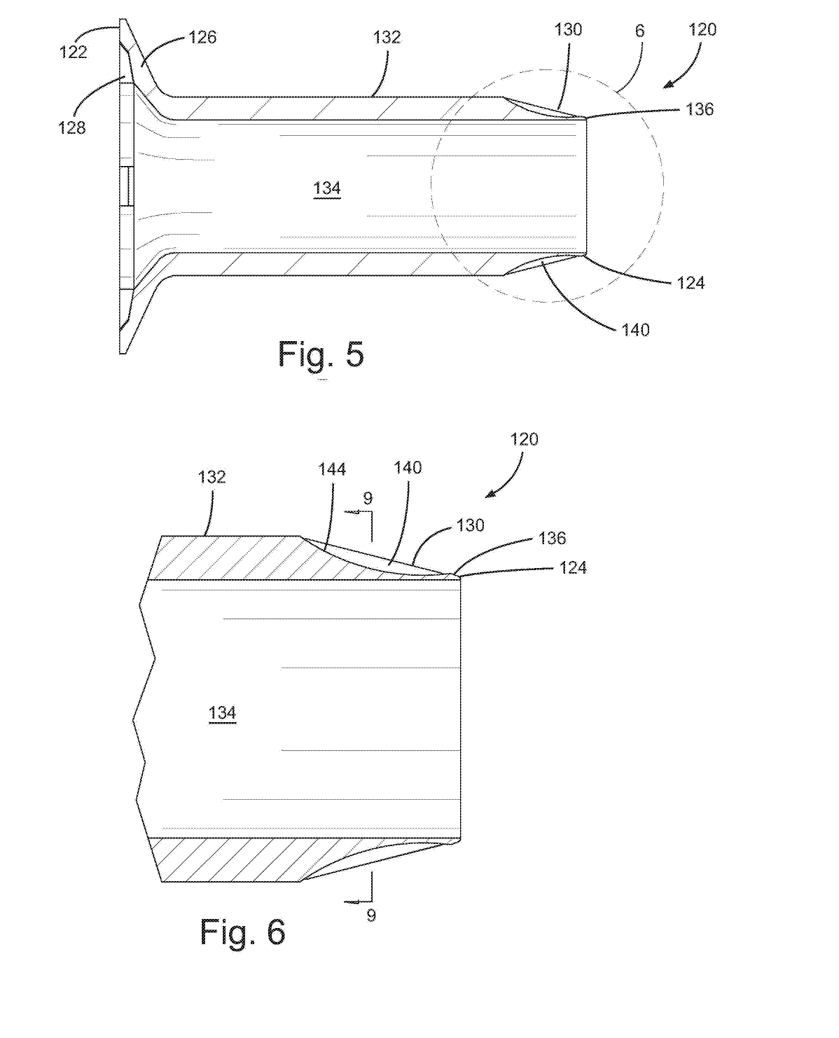

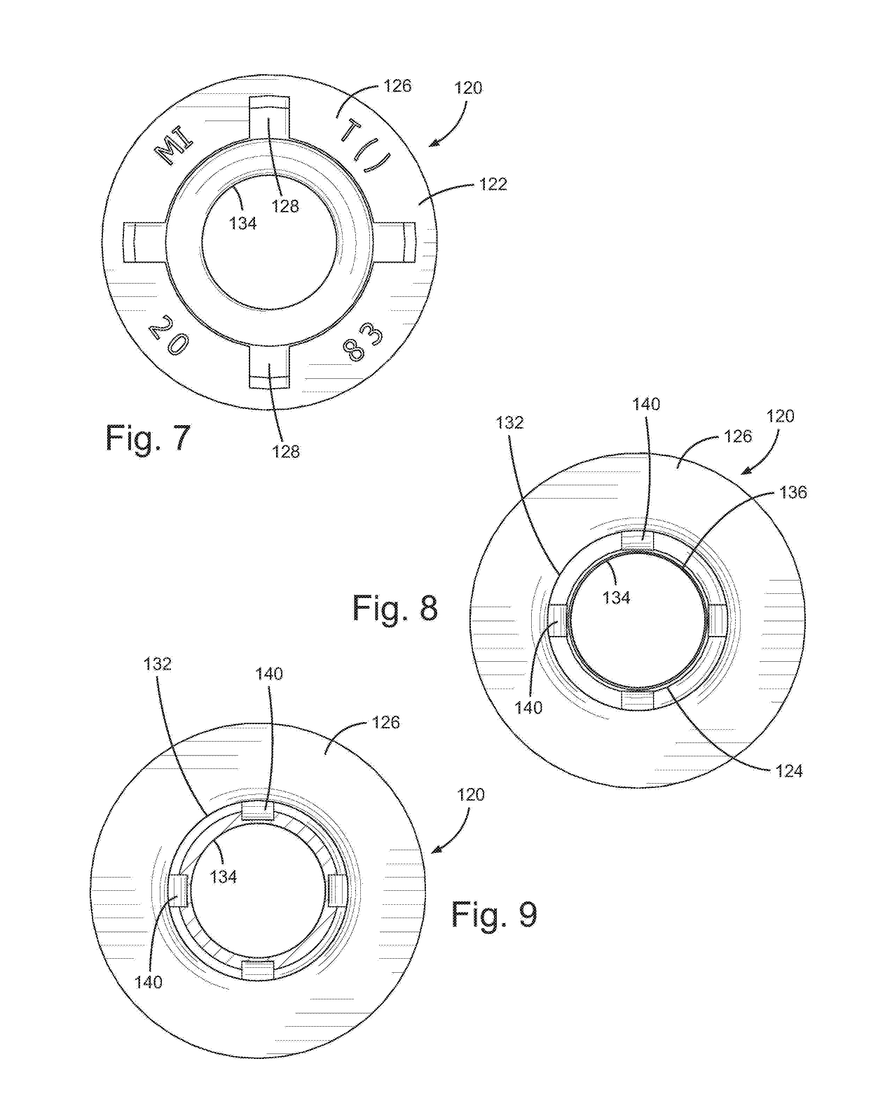

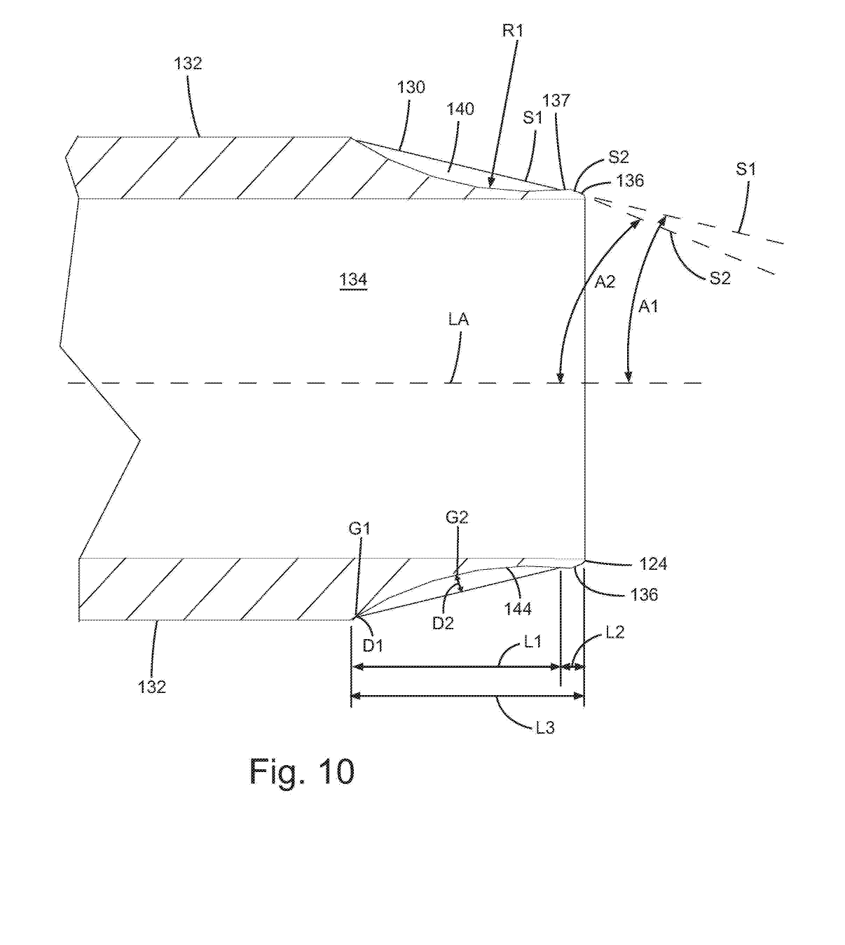

Referring now to FIGS. 3-10, body 120 is illustrated in isolated detail to further illustrate the configuration of body 120. As best seen in FIG. 10, body 120 may include a tapered nose portion 136 that may be at or nearest to the second end 124, and transition portion 137 between tapered ramp 130 and tapered nose portion 136. The tapered nose portion 136, transition portion 137 and tapered ramp 130 may each have a different slope. Tapered ramp 130 has slope S1 angled at angle A1 relative to longitudinal axis LA. In the illustrated embodiment, angle A1 is equal to generally 14 degrees. However, angle A1 could vary between generally 13.5 degrees and generally 14.5 degrees in different configurations. Tapered nose portion 136 has slope S2 angled at angle A2 relative to longitudinal axis LA. In the illustrated embodiment, angle A2 is equal to generally 24 degrees. However, angle A2 could vary between generally 22 degrees and generally 26 degrees in different configurations. In the illustrated embodiment, transition portion 137 is generally parallel to longitudinal axis LA. However, in other embodiments the slope for transition portion 137 could vary from parallel to longitudinal axis LA to generally 3 degrees with respect to longitudinal axis LA.

Also as best shown in FIG. 10, groove 140 has bottom surface 144. FIG. 10 is a cross-section taken along generally the midpoint of grooves 140, and the illustrated groove represents a maximum groove depth. In the illustrated embodiment, bottom surface 144 is curved, with radius R1. Groove 140 has a longitudinal length L1, with groove 140 starting a longitudinal length L2 away from end 124 and ending a longitudinal length L3 away from end 124.

As shown in FIG. 10, bottom surface 144 defines a variable depth relative to tapered ramp 130. A maximum depth D2 is located at an approximate longitudinal midpoint of groove 140, marked at point G2 in FIG. 10. In the illustrated embodiment, representing a 0.250″ sized fastener, depth D2 is equal to generally 0.0088″. However, depth D2 could vary between generally 0.008″ and generally 0.0095″ in different configurations. These variations apply to the 0.250″ size fastener and scale proportionately for other size fasteners. In the illustrated embodiment, minimum depth D1 is located near the intersection of bottom surface 144 and tapered ramp 130 and is less than 0.001″. While the illustrated embodiment has a maximum depth that is many multiples of the minimum depth, in other embodiments, smaller ratios between the minimum groove depth and maximum groove depth could be used, including 100:1, 50:1, 20:1, 12:1, 10:1, 8:1, 6:1, 4:1, or 2:1 (note that minimum and maximum groove depths could occur anywhere along the groove). In the illustrated embodiment, the depth of the groove approaches zero as the groove nears outer surface 132 and the end of tapered ramp 130. The depth of the groove also gradually increases for at least half a length of the groove as the groove extends away from outer surface 132 toward end 124.

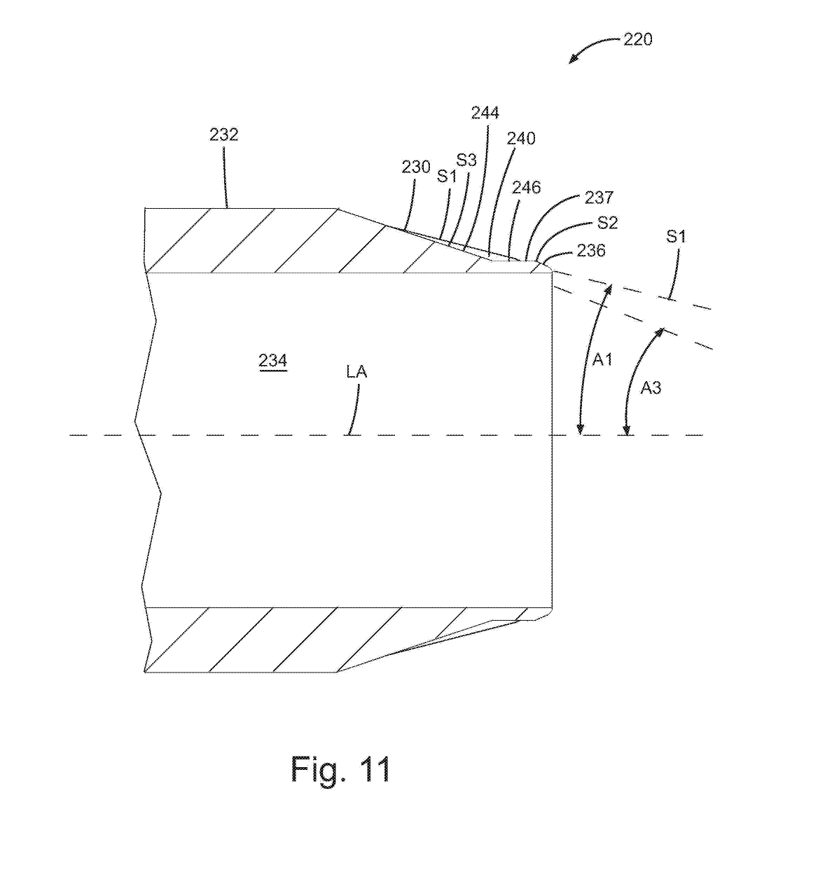

FIG. 11 illustrates an alternative configuration of a groove in a slotted expansion body. FIG. 11 shows an end of body 220 that includes tapered ramp 230, outer surface 232, bore 234, tapered nose portion 236, transition portion 237 and groove 240 extending along tapered ramp 230. FIG. 11 is a cross-section taken along generally the midpoint of grooves 240, and the illustrated groove represents a maximum groove depth. Groove 240 includes bottom surfaces 244 and 246. Like tapered ramp, 130, tapered ramp 230 has slope S1 angled at angle A1 relative to longitudinal axis LA. In the illustrated embodiment, angle A1 is equal to generally 14 degrees. However, angle A1 could vary between generally 13.5 degrees and generally 14.5 degrees in different configurations.

Bottom surface 244 has a slope S3 angled at angle A3 relative to longitudinal axis LA. In the illustrated embodiment, angle A1 is equal to generally 14 degrees. However, angle A3 could vary between generally 18 degrees and generally 20 degrees in different configurations. Bottom surface 246 is generally parallel to longitudinal axis LA (and transition portion 237). However, in other embodiments the slope for bottom surface 246 and transition portion 237 could vary from parallel to longitudinal axis LA to generally 3 degrees with respect to longitudinal axis LA.

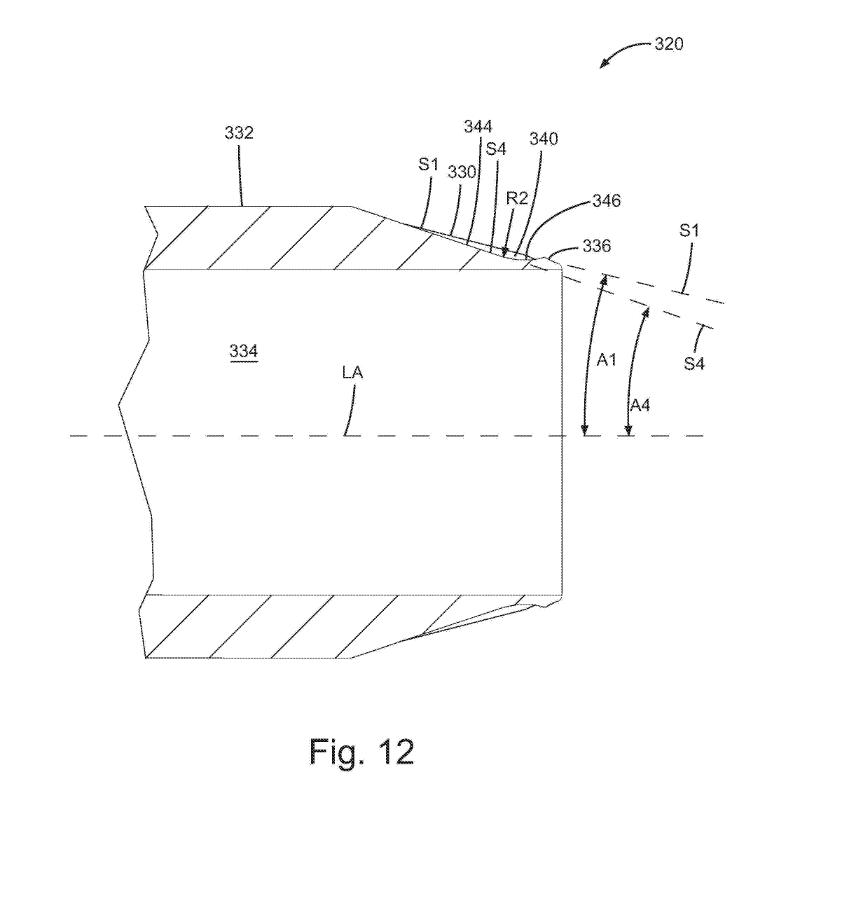

Referring now to FIG. 12, another alternative configuration of a groove in a slotted expansion body is shown. FIG. 12 shows an end of body 320 that includes tapered ramp 330, outer surface 332, bore 334, tapered nose portion 336, and groove 340 extending along tapered ramp 330. FIG. 12 is a cross-section taken along generally the midpoint of grooves 340, and the illustrated groove represents a maximum groove depth. Groove 340 includes bottom surfaces 344 and 346. Like tapered ramp 130, tapered ramp 330 has a slope S1 angled at angle A1 relative to longitudinal axis LA. In the illustrated embodiment, angle A1 is equal to generally 14 degrees. However, angle A1 could vary between generally 13.5 degrees and generally 14.5 degrees in different configurations.

Bottom surface 344 has a slope S4 angled at angle A4 relative to longitudinal axis LA. In the illustrated embodiment, angle A4 is equal to generally 18.5 degrees. However, angle A3 could vary between generally 18 degrees and generally 20 degrees in different configurations. In the illustrated embodiment, bottom surface 346 is curved, with radius R2.

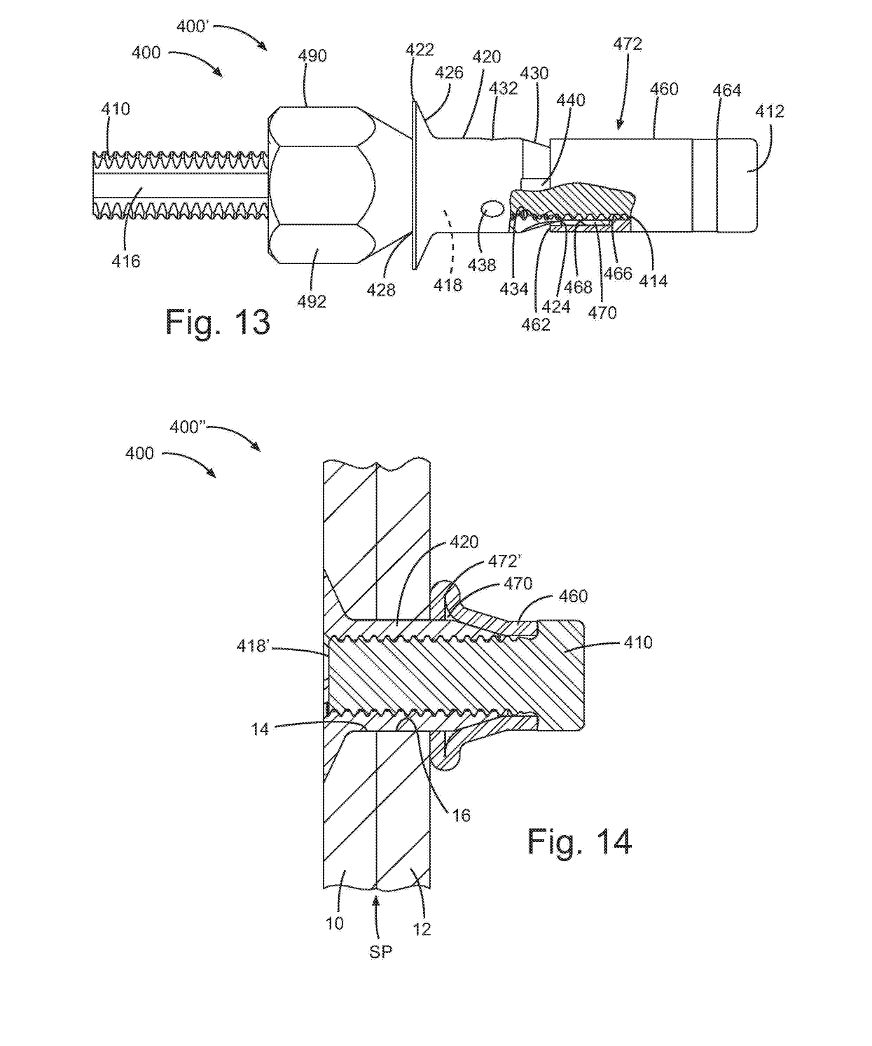

Referring now to FIG. 13, an alternative embodiment of a blind fastener is illustrated that includes a threaded expansion body. FIG. 13 illustrates blind fastener 400 that generally includes bolt 410, body 420, sleeve 460, and drive nut 490. Blind fastener 400 is illustrated in a pre-installation configuration 400′. Bolt 410 includes head 412, threaded portion 414, wrenching surfaces 416 and break feature 418 located between wrenching surfaces 416 and head 412.

Body 420 includes end 422, end 424, head 426 on end 422, outer surface 428 on head 426, tapered ramp 430 on second end 424, outer surface 432 and inner bore 434 that extends between ends 422 and 424. Tapered ramp 430 includes a plurality of grooves 440 extending longitudinally along tapered ramp 430. Inner bore 434 is threaded and is engaged with threaded portion 414 of bolt 410. Body 420 includes indent 438 that may function to lock threaded bore 434 and threaded portion 414 together to retain the illustrated relative position of the components in the absence of an applied relative torque between bolt 410 and body 420.

Sleeve 460 includes end 462, end 464, bore 466 extending between ends 462 and 464 and enlarged bore 468 on first end 462. As described below, sleeve 460 includes deformable portion 472 on end 462. At least part of deformable potion 472 includes a longitudinal length of enlarged bore 468. Insert 470 may optionally be positioned inside the void defined between enlarged bore 468 and bolt 410. Insert 470 may be constructed of a material that is more easily deformed than the material from which sleeve 460 is constructed. One example is plastic.

As shown in FIG. 13, bolt 410 extends through sleeve 460 and is threadingly engaged with body 420. Sleeve 460 is positioned between head 412 and tapered ramp 430, with end 462 abutting tapered ramp 430. Drive nut 490 is also threadingling engaged with bolt 410 and abuts surface 428 on body 420. Drive nut 490 includes wrenching surfaces 492. End 464 abuts head 412 such that relative rotation between drive nut 490 and bolt 410, in a tightening direction, moves head 412 toward body 420 thereby advancing sleeve 460 over tapered ramp 430. Grooves 440 reduce relative rotation between body 420 and sleeve 460 during such advancement.

Referring to FIG. 14, blind fastener 400 is illustrated in installed configuration 400″. Blind fastener 400 is fastening workpieces 10 and 12 together with workpieces 10 and 12 defining shear plane SP that is between workpieces 10 and 12. Blind fastener passes through apertures 14 and 16. In installed configuration 400″, tightening bolt 410 relative to body 420 has advanced sleeve 460 over tapered ramp 430 until end 462 abuts workpiece 12, and continues to bulb outwardly until the illustrated installed configuration 400″ is reached. Once configuration 400″ is reached, the applied torque between bolt 410 and body 420 exceeds a designed failure strength of break feature 418 resulting in the end of bolt 410 that includes wrenching surfaces 416 to break off, leaving sheared surface 418′ and ending the installation of blind fastener 100.

The different groove configurations shown in FIGS. 10, 11, and 12 are usable with expansion bodies 120 and 420.

The bolts described herein may be made from materials including, but not limited to, titanium alloy, A-286, and the like, and combinations thereof. Optionally, other materials may be satisfactory depending on the application. The wrenching flats or surfaces for the bolts (drive nuts) herein are made for engagement by an installation tool. During manufacture, once the bolt is heat treated and cleaned, the bolt should be lubricated with dry film lubricant (for example, a molybdenum disulfide lubricant in a phenolic binder that is dry to the touch) to reduce friction at an interface between threaded portions of the bolt and the nut as well as to contact surfaces on the body that sleeve 160 slides over during installation.

The sleeves of the present disclosure may be made from any malleable metal, for example, annealed AISI 304 stainless steel. Dry film lubricant may be applied to all surfaces of the sleeves to reduce friction. Lubricating the outer surfaces of the sleeve may help to achieve a larger bulbed flange. The sleeves may be formed by progressive forging operations or by machining from bar stock. The sleeves may alternatively be produced by machining alone. In some embodiments, the nut may include a bump that slightly deforms the internal threads on the nut to help lock the threads of the installed assembly together.

Regarding break features 118 or 418, the distal side of the break groove may flat, i.e., perpendicular to longitudinal axis LA, to maximize the thread engagement between bolt and nut. This may allow the length of the bolt and the nut to be minimized while still meeting tensile strength requirements (hence an additional weight saving feature). The geometrical configuration of the grooves or weakened regions can be varied to control the fracture characteristics of the break groove. If the tip of the break groove is sufficiently sharp, it acts as a stress concentration that may lead to a “brittle” type fracture. Conversely, if the tip of the break groove is sufficiently radiused or lengthened, then the amount of plastic deformation that occurs prior to fracture may increase, shifting the fracture to a ductile type tear. Desired performance characteristics for break grooves can be found by balancing considerations such as bolt material and groove geometry.

As used herein, the term “generally” may indicate that a measurement may be exact or may allow for a deviation, such as 10-20% plus or minus a measurement. Moreover, “generally” may refer to shapes that predominantly define a component, but may allow for variances from mathematical definitions of a shape.

The figures and illustrations included herewith are drawn to scale and represent a 0.250 inch (6.35 mm) size blind fastener and components for a 0.250 inch (6.35 mm) size blind fastener. It is noted, however, that the dimensions of various components, figures, or the like may be modified and may incorporated aspects of this disclosure. Moreover, described embodiments may allow for deviations from described measurements unless explicitly stated or context suggests otherwise.

Described herein is a blind fastener for inserting through aligned apertures, the blind fastener comprising a bolt comprising a bolt head and an externally threaded portion, a body comprising a body head on a first end, an external tapered ramp surface on a second end, wherein the external tapered ramp surface comprises at least one groove extending along the external tapered ramp surface and wherein, the at least one groove defines a variable maximum depth relative to the external tapered ramp surface such that at a first point the maximum depth of the at least one groove is at least twice as deep as at a second point along a length of the at least one groove, and a sleeve comprising a first end, a deformable portion adjacent the first end, a second end, and a sleeve bore extending through the sleeve along the longitudinal axis, wherein the bolt passes through the sleeve bore, wherein, first end of the sleeve abuts the body, and wherein the deformable portion is deformable over the at least one groove to reduce rotation of the body relative the sleeve.

In another aspect, the blind fastener may further comprises a nut comprising an internally threaded portion, wherein the nut is threadingly engaged with the externally threaded portion of the bolt and wherein the sleeve is positioned between the nut and the body. The external tapered ramp surface includes a tapered nose portion proximate to the second end. The at least one groove does not extend longitudinally along the tapered nose portion. A slope of the tapered nose portion is different than a slope of the external tapered ramp surface. The slope of the tapered nose portion is steeper relative to the longitudinal axis than the slope of the external tapered ramp surface. A bottom surface of the at least one groove is radiused along the length of the groove. A maximum depth of the at least one groove is positioned near a longitudinal general midpoint of the external tapered ramp surface. A maximum depth of the at least one groove is positioned between a longitudinal general midpoint of the external tapered ramp surface and the second end of the body. A bottom surface of the at least one groove includes a first surface having a first gradient and a second surface having a second gradient different than the first gradient. The first gradient and second gradient are different than the slope of the external tapered ramp surface. The first surface is at least one of generally parallel to the longitudinal axis, or curved such that the first surface has a variable gradient along a length of the first surface. In an example, when moving longitudinally over the external tapered ramp, a portion of the sleeve extrudes at least partway into the at least one groove. The at least one groove extends substantially in a longitudinal direction relative the longitudinal axis. The deformable portion comprises an enlarged bore that has a larger internal diameter than the sleeve bore. The blind fastener may further comprise an insert positioned within the enlarged bore between the sleeve and the bolt.

A blind fastener for fastening workpieces together may comprise a bolt comprising an externally threaded portion, a body comprising, an internally threaded bore that operatively receives the externally threaded portion, a frustoconical portion comprising an external tapered ramp surface and at least one groove extending along the external tapered ramp surface and wherein, the at least one groove defines a variable maximum depth relative to the external tapered ramp surface such that at a first point the maximum depth of the groove is at least twice as deep as at a second point along the length of the at least one groove. The blind fastener may further comprise a sleeve comprising a first end, a deformable portion adjacent the first end, and a second end, wherein the sleeve defines a sleeve bore extending through the sleeve along the longitudinal axis that operatively receives the bolt, and wherein the deformable portion is operatively deformed within the at least one groove when compression force is applied to the sleeve. It is noted that the blind fastener may further comprise a nut comprising an internally threaded portion threadingly engaged with the externally threaded portion, wherein the sleeve is positioned between the nut and the body, wherein rotation of the bolt relative to the body longitudinally moves and laterally expands the deformable portion over the external tapered ramp surface until the blind fastener is in an installed configuration. The depth of the at least one groove is nearly zero near a junction between the external tapered ramp surface and an outer surface of the body.

Also described is a blind fastener for inserting through aligned apertures of first and second overlapping workpieces to secure the workpieces together, the overlapping workpieces defining a shear plane between them, where the blind fastener has a pre-installation configuration and an installed configuration, the blind fastener comprising a bolt comprising a bolt head and an externally threaded portion; a body comprising a body head on a first end, an external tapered ramp surface on a second end, and an outer surface between the body head and the external tapered ramp surface, wherein the body defines a body bore extending through the body along a longitudinal axis, wherein at least a portion of the body bore is internally threaded and threadingly engaged with the externally threaded portion, wherein the external tapered ramp surface defines a groove extending along the external tapered ramp surface and wherein, along a length of the groove, the groove defines a variable maximum depth relative to the external tapered ramp surface such that at a first point the maximum depth of the groove is at least twice as deep as at a second point along the length of the groove; and a sleeve comprising a first end, a deformable portion adjacent the first end, and a second end, wherein the sleeve defines a sleeve bore extending through the sleeve along the longitudinal axis, wherein the bolt passes through the sleeve bore, wherein, in the pre-installation configuration, the first end of the sleeve abuts the body, wherein the sleeve is positioned between the bolt head and the body, wherein rotation of the bolt relative to the body longitudinally moves and laterally expands the deformable portion over the external tapered ramp surface until the blind fastener is in the installed configuration against the second overlapping panel and wherein the sleeve interacts with the at least one groove when moving longitudinally relative to the external tapered ramp thereby reducing rotation of the sleeve relative to the body during installation.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

What is claimed is:

1. A blind fastener for inserting through aligned apertures, the blind fastener comprising:
a bolt comprising a bolt head and an externally threaded portion;
a body comprising a body head on a first end, an external tapered ramp surface on a second end, wherein the external tapered ramp surface comprises at least one groove extending along the external tapered ramp surface and wherein, the at least one groove defines a variable maximum depth relative to the external tapered ramp surface such that at a first point the maximum depth of the at least one groove is at least twice as deep as at a second point along a length of the at least one groove; and
a sleeve comprising a first end, a deformable portion adjacent the first end, a second end, and a sleeve bore extending through the sleeve along the longitudinal axis, wherein the bolt passes through the sleeve bore, wherein, first end of the sleeve abuts the body, and
wherein the deformable portion is deformable over the at least one groove to reduce rotation of the body relative the sleeve.

2. The blind fastener of claim 1, wherein the blind fastener further comprises a nut comprising an internally threaded portion, wherein the nut is threadingly engaged with the externally threaded portion of the bolt and wherein the sleeve is positioned between the nut and the body.

3. The blind fastener of claim 1, wherein the external tapered ramp surface includes a tapered nose portion proximate to the second end.

4. The blind fastener of claim 3, wherein the at least one groove does not extend longitudinally along the tapered nose portion.

5. The blind fastener of any one of claims 3, wherein a slope of the tapered nose portion is different than a slope of the external tapered ramp surface.

6. The blind fastener of claim 5, wherein the slope of the tapered nose portion is steeper relative to the longitudinal axis than the slope of the external tapered ramp surface.

7. The blind fastener of claim 1, wherein a bottom surface of the at least one groove is radiused along the length of the groove.

8. The blind fastener of claim 7, wherein a maximum depth of the at least one groove is positioned near a longitudinal general midpoint of the external tapered ramp surface.

9. The blind fastener of claim 7, wherein a maximum depth of the at least one groove is positioned between a longitudinal general midpoint of the external tapered ramp surface and the second end of the body.

10. The blind fastener of claim 1, wherein a bottom surface of the at least one groove includes a first surface having a first gradient and a second surface having a second gradient different than the first gradient.

11. The blind fastener of claim 10, wherein the first gradient and second gradient are different than the slope of the external tapered ramp surface.

12. The blind fastener of claim 10, wherein the first surface is at least one of generally parallel to the longitudinal axis, or curved such that the first surface has a variable gradient along a length of the first surface.

13. The blind fastener of claim 1, wherein, when moving longitudinally over the external tapered ramp, a portion of the sleeve extrudes at least partway into the at least one groove.

14. The blind fastener of claim 1, wherein at least one groove extends substantially in a longitudinal direction relative the longitudinal axis.

15. The blind fastener of claim 1, wherein the deformable portion comprises an enlarged bore that has a larger internal diameter than the sleeve bore.

16. The blind fastener of claim 15, further comprising an insert positioned within the enlarged bore between the sleeve and the bolt.

17. A blind fastener for fastening workpieces together, the blind fastener comprising:
a bolt comprising an externally threaded portion;
a body comprising:
an internally threaded bore that operatively receives the externally threaded portion,
a frustoconical portion comprising an external tapered ramp surface; and
at least one groove extending along the external tapered ramp surface and wherein, the at least one groove defines a variable maximum depth relative to the external tapered ramp surface such that at a first point the maximum depth of the groove is at least twice as deep as at a second point along the length of the at least one groove;
a sleeve comprising a first end, a deformable portion adjacent the first end, and a second end, wherein the sleeve defines a sleeve bore extending through the sleeve along the longitudinal axis that operatively receives the bolt, and wherein the deformable portion is operatively deformed within the at least one groove when compression force is applied to the sleeve.

18. The blind fastener of claim 17, further comprising a nut comprising an internally threaded portion threadingly engaged with the externally threaded portion, wherein the sleeve is positioned between the nut and the body, wherein rotation of the bolt relative to the body longitudinally moves and laterally expands the deformable portion over the external tapered ramp surface until the blind fastener is in an installed configuration.

19. The blind fastener of claim 17, wherein the depth of the at least one groove is nearly zero near a junction between the external tapered ramp surface and an outer surface of the body.

20. A blind fastener for inserting through aligned apertures of first and second overlapping workpieces to secure the workpieces together, the overlapping workpieces defining a shear plane between them, where the blind fastener has a pre-installation configuration and an installed configuration, the blind fastener comprising:
a bolt comprising a bolt head and an externally threaded portion;
a body comprising a body head on a first end, an external tapered ramp surface on a second end, and an outer surface between the body head and the external tapered ramp surface, wherein the body defines a body bore extending through the body along a longitudinal axis, wherein at least a portion of the body bore is internally threaded and threadingly engaged with the externally threaded portion, wherein the external tapered ramp surface defines a groove extending along the external tapered ramp surface and wherein, along a length of the groove, the groove defines a variable maximum depth relative to the external tapered ramp surface such that at a first point the maximum depth of the groove is at least twice as deep as at a second point along the length of the groove; and
a sleeve comprising a first end, a deformable portion adjacent the first end, and a second end, wherein the sleeve defines a sleeve bore extending through the sleeve along the longitudinal axis, wherein the bolt passes through the sleeve bore, wherein, in the pre-installation configuration, the first end of the sleeve abuts the body, wherein the sleeve is positioned between the bolt head and the body, wherein rotation of the bolt relative to the body longitudinally moves and laterally expands the deformable portion over the external tapered ramp surface until the blind fastener is in the installed configuration against the second overlapping panel and wherein the sleeve interacts with the at least one groove when moving longitudinally relative to the external tapered ramp thereby reducing rotation of the sleeve relative to the body during installation.
